(19) United States
(12) Patent Application Publication
(10) Pub. No.: US 2025/0222419 A1
(43) Pub. Date: Jul. 10, 2025

(54) FLOOD REACTORS AND RELATED METHODS

(71) Applicant: Massachusetts Institute of Technology, Cambridge, MA (US)

(72) Inventors: Mark Donahue, Littleton, MA (US); Erik Limpaecher, Concord, MA (US); Eric Morgan, Harvard, MA (US); Erin Looney, Newton, MA (US)

(73) Assignee: Massachusetts Institute of Technology, Cambridge, MA (US)

(21) Appl. No.: 19/009,899

(22) Filed: Jan. 3, 2025

Related U.S. Application Data
(60) Provisional application No. 63/618,270, filed on Jan. 5, 2024.

(51) Int. Cl. B01J 8/00; B01J 4/00; B01J 8/02; C01B 3/08

(52) U.S. Cl. CPC B01J 8/001; B01J 4/001; B01J 8/0278; C01B 3/08; B01J 2204/002; B01J 2208/00539

(57) ABSTRACT

Reactors and related methods directed to the production of hydrogen gas and/or other appropriate gases are described. In some embodiments, a reactor may include a housing, a support configured to maintain a reactant at a predetermined location within an internal volume of the housing, and a pressure source configured to maintain a level and pressure of a liquid within the internal volume to selectively isolate and expose the reactant relative to the liquid.

### RELATED APPLICATIONS

This application claims priority under 35 U.S.C. § 119 (e) to U.S. Provisional Application No. 63/618,270 filed Jan. 5, 2024, which is incorporated herein by reference in its entirety for all purposes.

### GOVERNMENT LICENSE RIGHTS

This invention was made with government support under FA8702-15-D-0001 awarded by the U.S. Air Force. The government has certain rights in the invention.

### TECHNICAL FIELD

Disclosed embodiments are related to flood reactors and related methods of use.

### BACKGROUND

Hydrogen gas has been well recognized as an emission-free fuel holding promise for a more sustainable energy economy compared to fossil fuels. Oxidation-reduction reactions involving metals can produce hydrogen on-demand, eliminating the cost and/or storage of hydrogen as a gas or liquid at high-pressure. Aluminum (Al), for example, has an energy density about two times greater than diesel fuel and forty times greater than lithium ion, and reacts with water to produce hydrogen.

### SUMMARY

In some embodiments, a reactor for producing gas includes a housing including an internal volume, a support configured to support a reactant in a predetermined location within the internal volume. The predetermined location is spaced apart from one or more internal surfaces of the internal volume. The reactor further includes a pressure source configured to maintain a pressure of a liquid in the internal volume greater than or equal to a minimum threshold pressure.

In some embodiments, a method of producing gas includes combining a reactant and a liquid in an internal volume of a housing to produce the gas and altering a vertical height of the liquid in a direction of gravity within the internal volume in response to changes in a pressure within the internal volume to selectively expose the water reactive material from the liquid.

Other advantages and novel features of the present disclosure will become apparent from the following detailed description of various non-limiting embodiments of the disclosure when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present disclosure will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure. In the figures:

FIG. 1 is a flow diagram of a method for generating hydrogen according to one embodiment;

FIG. 2A is a schematic of a reactor when an internal pressure is within a desired pressure range with the reactant exposed to a liquid contained therein according to one embodiment;

FIG. 2B is a schematic of the reactor of FIG. 2A when an internal pressure is greater than a threshold isolation pressure and the reactant is isolated from the liquid;

FIG. 3A. is a schematic of a reactor when an internal pressure is within a desired pressure range with the reactant exposed to a liquid contained therein according to one embodiment;

FIG. 3B is a schematic of the reactor of FIG. 3A when an internal pressure is greater than a threshold isolation pressure and the reactant is isolated from the liquid;

FIG. 4A. is a schematic of a reactor when an internal pressure is within a desired pressure range with the reactant exposed to a liquid contained therein according to one embodiment; and

FIG. 4B is a schematic of the flooding reactor of FIG. 4A when an internal pressure is greater than a threshold isolation pressure and the reactant is isolated from the liquid.

### DETAILED DESCRIPTION

Continuously producing hydrogen within a desired pressure range over long durations using a reactant such as a water reactive material and a liquid such as water can be difficult. Conventional reactors may not control how the reactant is exposed to the liquid during a reaction. As such, conventional reactors may not be able to easily control a reaction rate between the reactant and a liquid within the reactor once combined which can lead to excessive gas generation rates and/or increased pressures within a reactor. This may lead to undesirable flow rates of hydrogen from the reactor to associated systems or equipment. Excessive pressures may also damage equipment and/or systems that are connected to the reactor. It is also appreciated that excessive pressures may lead to failure of the reactor itself.

In view of the above, the Inventors have recognized that it may be desirable to produce hydrogen within a desired pressure range. More specifically, the Inventors have appreciated that it may be possible to control the reaction between a reactant and a liquid present within an internal volume of a reactor by controlling a vertical height of the liquid within the reactor relative to a direction of gravity during operation based at least in part on a pressure within the internal volume of the reactor. Thus, a reactant maintained in one or more specific locations within an internal volume of the reactor may be selectively exposed to the liquid when a pressure is less than a threshold pressure and may be isolated from the liquid when the pressure is greater than a threshold pressure.

In one embodiment, a reactor may be configured to maintain an internal pressure of a reactor within a desired pressure range to control a height of the liquid within the reactor relative to a direction of gravity during operation. In such an embodiment, the reactant may be held in one or more specific locations within an internal volume of the reactor and a height (i.e. water level) of the liquid (e.g. water) in the internal volume is varied based at least in part on the internal pressure within the internal volume. As elaborated on further below, this control may either be a passive control based on a design of the reactor and/or active controls and systems may be used to alter the height of the liquid within an internal volume of the reactor. For example, the Inventors have also recognized that in some embodiments, the flooding can be accomplished passively using a compliant volume. In other embodiments, the flooding may be accomplished actively using a pump and an outlet.

In the above embodiment, when the internal pressure is within a desired operational range, the liquid may flood over the reactant. Thus, the reactant and liquid may be able to react and create hydrogen or other appropriate gas. As hydrogen is generated, the internal pressure may increase. If the pressure is greater than a threshold pressure, the height of the liquid may be decreased such that the liquid surface is vertically below the reactant which may stop the reaction. During operation of the reactor, hydrogen may be flowed out of the reactor through an outlet in fluid communication with the internal volume. As hydrogen gas flows out of the reactor, this may lower the internal pressure of the reactor. When the pressure is less than the threshold pressure, the liquid height may be increased to a height sufficient to again flood over the reactant and restart the generation of hydrogen. For example, as elaborated on further below, a minimum pressure may be maintained within the reactor using the liquid. Thus, as the liquid height increases to maintain the desired minimum pressure in the reactor internal volume, the liquid may rise to a level vertically above the reactant relative to a direction of gravity. Thus, pressure within the reactor may be used to control the overall reaction between the reactant and liquid.

As noted above, either active or passively controlled systems may be used to implement the reactors and methods disclosed herein. For example, actively controlled, pumps, valves, and/or other appropriate structures may be used to actively control a level of water or other liquid within a reactor. Alternatively, in other embodiments, passively controlled compliant volumes located either internal or external to the internal volume (e.g., gas bladders, clastic diaphragms, accumulators, expansion tanks, etc.) may be used to passively control a level of water or other liquid within a reactor. Specific embodiments related to implementing these types of active and passive reactors are detailed further below in regard to the figures.

In some embodiments, a reactor may include a support that is configured to support the reactant in one or more predetermined locations within an internal volume of the reactor to facilitate selectively exposing the reactant to the water or other liquid. Supporting a reactant in more than one location may be beneficial to controlling the reaction by controlling how much reactant is exposed to a liquid depending on a level of liquid in the internal volume. The support may comprise any appropriate material and structure capable of supporting the reactant in the desired location. The support may be made from a substantially inert material relative to the reactant and liquid. Additionally or alternatively, the support may be configured to be resistant to hydrogen embrittlement. Appropriate materials may include, but are not limited to, polymer coated metals, non-reactive metals such as stainless steel, polymers, ceramics, and/or any other appropriate material. In some embodiments, the support may be flexible. In other embodiments, the support may be rigid. For example, depending on the embodiment, the support may comprise a flexible tether, a rigid tether, a rod, shelf, and/or any other appropriate member configured to support the reactant at a desired location/height relative to a bottom of the reactor when a base of the reactor is positioned on a level surface.

Depending on the embodiment, the reactant may also be contained in a reactant container connected to the support. Such a reactant container may have any appropriate construction including: a perforated, porous, or mesh material (e.g. plastic, non-reactive metal, etc.); a basket construction; and/or any other appropriate construction configured to contain the reactant while exposing the reactant to a liquid contained in the internal volume of a reactor. The reactant container may include any appropriate pore size, porosity, mesh size, etc. as the disclosure is not so limited.

In the above embodiment and other embodiments disclosed herein, a reaction between a reactant such as a water reactive material and water for generating hydrogen is described. However, it should be appreciated that the reactors and methods disclosed herein may be used to control a reaction between any reactant and liquid capable of generating a gas. Thus, while the embodiments disclosed herein are primarily described relative to hydrogen generation, for the sake of clarity, any of the embodiments disclosed herein may be used with other reactants and liquids capable of producing gases other than hydrogen.

Depending on the embodiment, the internal pressure within an internal volume of a reactor may be maintained at any desirable pressure. In some embodiments, a threshold isolation pressure above which a reactant may be isolated from a liquid in the reactor be greater than or equal to 50 kPa, 100 kPa, 200 kPa, 300 kPa, 400 kPa, 500 kPa, 600 kPa, 700 kPa, 800 kPa, 900 kPa, 1,000 kPa, 1,100 kPa, 1,200 kPa, 1,300 kPa, 1,400 kPa, 1,500 kPa, 1,600 kPa, 1,700 kPa, 1,800 kPa, 1,900 kPa, or other appropriate range. In some embodiments, the threshold isolation pressure may be less than or equal to 2,000 kPa, 1,900 kPa, 1,800 kPa, 1,700 kPa, 1,600 kPa, 1,500 kPa, 1,400 kPa, 1,300 kPa, 1,200 kPa, 1,100 kPa, 1,000 kPa, 900 kPa, 800 kPa, 700 kPa, 600 kPa, 500 kPa, 400 kPa, 300 kPa, 200 kPa, 100 kPa, or other appropriate range. Combinations of the above are also contemplated. For example, in some embodiments, the threshold isolation pressure may be between or equal to 50 kPa and 2,000 kPa. Of course, depending on the application, other pressures greater than or less than those noted above are also contemplated. The pressures noted above may be gauge pressures corresponding to a difference between an absolute pressure and the ambient pressure. The pressures may be measured using an appropriate pressure sensor calibrated to measure 0 pressure at a standard atmospheric pressure of 100 kPa.

In some embodiments, the pressure within an internal volume of a reactor may be maintained within a desired pressure range by controlling the pressure to be greater than a minimum threshold pressure. In some embodiments, the minimum threshold pressure may be greater than or equal to 5%, 10%, 15%, 20%, 25%, 30%, 35%, 40%, 45%, or other appropriate percentage of the threshold isolation pressure. The minimum threshold pressure may also be less than or equal to 50%, 45%, 40%, 35%, 30%, 25%, 20%, 15%, 10% or other appropriate percentage of the threshold isolation pressure. Combinations of the above are also contemplated. For example, in some embodiments, the minimum threshold pressure may be between or equal to 15% and 40% of the threshold isolation pressure. In other embodiments, the minimum threshold pressure may be between or equal to 5% and 50% of the threshold isolation pressure. The above percentages are referenced to the above noted gauge pressures of the threshold isolation pressure. For example, the minimum threshold pressure may be calculated as a percentage of a difference between the threshold isolation pressures and a standard absolute pressure of 100 kPa.

The reactors disclosed herein may be any appropriate size to provide sufficient hydrogen generation for a desired application. For example, a relatively smaller volume may be desirable to produce hydrogen for a small-scale application such as powering a stove, a light, etc. Smaller reactors may be advantageous due to their mobility, ability to be quickly set up, etc. A relatively larger internal volume may be desirable to power a large-scale system such as a hydrogen fuel cell or multiple systems utilizing hydrogen. Depending on the embodiment, the internal volume of the reactor may be greater than or equal to 0.5 Liters (L), 0.75 L, 1.0 L, 1.25 L, 1.5 L, 1.75 L, 2.0 L, 2.25 L, 2.5 L, 2.75 L, 3.0 L, 3.25 L, 3.5 L, 3.75 L, 4.0 L, 4.25 L, 4.5 L, 4.75 L, or other appropriate range. In some embodiments, the internal volume may be less than or equal to 50.0 L, 5.0 L, 4.75 L, 4.5 L, 4.25 L, 4.0 L, 3.75 L, 3.5 L, 3.25 L, 3.0 L, 2.75 L, 2.5 L, 2.25 L, 2.0L, 1.75 L, 1.5 L, 1.25 L, 1.0 L, 0.75 L, or other appropriate range. Combinations of the above are also contemplated. For example, in one embodiment, the internal volume may be between or equal to 2.25 L and 3.75 L. In another embodiment, the internal volume may be between 0.5 L and 5 L, 0.5L and 50 L, or other appropriate volumes. Other ranges are also contemplated as the disclosure is not so limited.

It is contemplated that depending on the embodiment, the housing may comprise any appropriate material such as polymer coated metals (e.g., polymer coated aluminum), stainless steel, plastic, composites, and/or any other appropriate material substantially unreactive with the reactants contained therein and capable of supporting the applied pressures and temperatures during operation. Relatedly, the disclosed bladders, accumulators, and other structures for providing a compliant volume may also comprise any appropriate material including, but not limited to, rubbers, latex, flexible plastics, and/or other elastic materials that are substantially unreactive with the reactants and capable of withstanding the applied pressures and temperatures.

The Inventors have appreciated that the response of a reactor can be controlled in a number of ways. For example, for a reactor including a compliant volume, a compliance of the volume, an amount of pre-pressurization, a total volume of the compliant volume, and/or other parameters may be selected to provide a desired response. Another factor that may be manipulated is a total amount of water within the reactor relative to an overall volume of an internal volume of the reactor. For example, the total amount of water in the system may affect an amount of head space where the hydrogen may accumulate during the reaction. Similarly, the sizing and flow resistances of the gas outlet, a water outlet where available, a flow rate provided from a pump or other source of pressurized liquid, and/or any number of other parameters may also be selected to control the performance of a reactor. Accordingly, the disclosed reactors and may be controlled in a number of different ways to appropriately provide a desired range of operational pressures, a flow rate of pressurized hydrogen, and/or other desired operational parameters.

The disclosed embodiments and related methods may be used in any appropriate application to produce hydrogen or any other desired gas at a desired pressure. For example, the produced hydrogen may be used for filling lighter than air systems such as balloons (e.g., high altitude balloons, tethered balloons), blimps, and other appropriate systems. The produced hydrogen gas may also be used to produce electricity and/or mechanical work (e.g., via a fuel cell, turbine, and/or internal combustion engine). Thus, the disclosed systems and corresponding produced hydrogen may be used for any number of different applications. In some specific embodiments, hydrogen gas can be used to fill removeable, low pressure hydrogen canisters that can be integrated into systems such as fuel cells, unmanned aerial vehicles, ground vehicles, ground sensors, cookstoves, or any other appropriate system. The Inventors have realized that low pressure hydrogen can be fed directly into systems to provide electrical power. For example, low pressure hydrogen may be used for continuous power generation for remote sensors, remote command posts, remote charging, or other remote and/or unattended applications. Low pressure hydrogen may also be directly supplied to low-pressure fuel cells. Other applications of the disclosed reactors and methods are also contemplated as the disclosure is not so limited.

The disclosed systems and methods may offer various benefits such as production of hydrogen within a desired pressure range, minimal setup time, reduced operational complexity, automated control of the reaction, passive control of the reaction, portability of the reactor, and/or the ability to reuse the reactor multiple times. The disclosed designs may also avoid the high pressure and/or higher temperature considerations that other reactor designs may have. The reactors may also be simple to use relative to other reactor designs. For example, a user may not need to control or monitor a reactor until the reactant is expended and the reactor is cleaned. Of course, benefits other than those noted above are also possible as the disclosure is not limited to only providing the above benefits. The flooding and unflooding of the reactant may also serve as an effective means to wash away accumulated reactant byproduct (e.g., aluminum hydroxide, etc.) that may be formed during a reaction, which could otherwise slow or quench the reaction. It is also appreciated that the disclosed embodiments where the reactant is flooded with the water may produce a higher yield of hydrogen compared to some conventional reactors that trickle water over a reactant.

Another benefit of the disclosed embodiments is that the disclosed embodiments may be self-regulating and provide a continuous source of self-pressurized hydrogen until the reactant is expended. With the disclosed embodiments, the reactant can be separated from the water either passively or via automated control, to limit the reaction rate and temperature. Such self-regulation may be beneficial to improve safety over some conventional reactors that permanently flood a reactant. Additionally, the exposure and isolation of the reactant to the liquid within the internal volume may generate a breathing or engine-type behavior throughout the reaction which may be beneficial to producing mechanical work, for example by using a turbine.

In certain embodiments, and as explained in greater detail herein, the water reactive material may comprise aluminum or an alloy thereof. Without wishing to be bound by theory, water and aluminum react to produce hydrogen gas according to either of the following exothermic reactions shown in reactions (1) and (2):

2Al+4H₂O→3H₂+2AlO(OH)+Q1 (1)

2Al+6H₂O→3H₂+2Al(OH)₃+Q2 (2)

where Q1 and/or Q2 are heat.

Depending on the embodiment, the water reactive material may comprise any appropriate shape and/or form. For example, the material may comprise pellets, balls, powders, particles, chunks of material, and/or other appropriate form factors. In some embodiments, smaller water reactive materials, or other reactants, may be contained in a desired location within a reactor through the use meshes, baskets, filters, and/or other appropriate arrangements capable of maintaining the material at a desired location within the reactor as noted elsewhere herein. The water reactive material may be regularly shaped, such as spherical, or may be irregularly shaped chunks. The size of the water reactive material may be uniform or varied. Alternatively, the water reactive particles may be provided in a more continuous form, such as a powder with any appropriate size distribution for a desired application. Depending on the embodiment, the size distribution may be substantially uniform, such that the size of particles within the powder are substantially homogeneous.

In some embodiments, the water reactive material may have an average maximum transverse dimension that is greater than or equal to 100 μm, 250 μm, 500 μm, 1 mm, 5 mm, 1 cm, 5 cm, or other appropriate ranges. The average maximum transverse dimension may be less than or equal to 10 cm, 8 cm, 5 cm, 2 cm, 1 cm, 5 mm, 1 mm, 500 μm, 250 μm, or other appropriate ranges. Combinations of the above are contemplated. For example, in some embodiments, the water reactive material may have an average maximum transverse dimension between or equal to 100 μm and 10 cm. Controlling the average size of the water reactive material may be advantageous to dispense the material into a reaction chamber at a desired rate. Additionally or alternatively, controlling the size of the water reactive material may be advantageous to minimize clogging and/or jamming while dispensing the material into the reaction chamber.

As mentioned above, hydrogen gas is produced by exposing water reactive material to water. In some such embodiments, the rate and amount of hydrogen gas produced can be controlled by modifying the type and concentration of certain water reactive materials. In some embodiments, the water reactive material comprises aluminum, as described above in relation to reactions (1) and (2). However, other metals may also be used depending on the particular embodiment. Non-limiting examples of water reactive materials that may be used are aluminum, lithium, sodium, magnesium, zinc, boron, beryllium, alloys thereof, and/or mixtures thereof.

The water reactive materials, in some embodiments, comprise an activating composition that is permeated into the grain boundaries and/or subgrain boundaries of the reactant (e.g. aluminum) to facilitate its reaction with water. For example, a reactant may include aluminum combined with gallium and/or indium. In some instances, the activating composition may be a eutectic, or close to eutectic composition, including for example a cutectic composition of gallium and indium. In one such embodiment, the activating composition may comprise gallium and indium where the portion of the activating composition may have a composition of about 70 wt. % to 80 wt. % gallium and 20 wt. % to 30 wt. % indium, though other weight percentages are also possible. Without wishing to be bound by theory, gallium and/or indium may permeate through one or more grain boundaries and/or subgrain boundaries of the reactant (e.g., aluminum).

In certain embodiments, the activating composition may be incorporated into an alloy with the reactant. A metal alloy may comprise any activating composition in any of a variety of suitable amounts. In some embodiments, for example, the metal alloy comprises greater than or equal to 0.1 wt. % of the activating composition, greater than or equal to 1 wt. %, greater than or equal to 5 wt. %, greater than or equal to 15 wt. %, greater than or equal to 30 wt. %, or greater than or equal to 45 wt. % of the activating composition based on the total weight of the metal alloy. In certain embodiments, the metal alloy comprises less than or equal to 50 wt. %, less than or equal to 40 wt. %, less than or equal to 30 wt. %, less than or equal to 20 wt. %, less than or equal to 10 wt. %, less than or equal to 5 wt. %, or less than or equal to 1 wt. % of the activating composition, based on the total weight of the metal alloy. Combinations of the above recited ranges are also possible (e.g., the metal alloy comprises greater than or equal to 0.1 wt. % and less than or equal to 50 wt. % of the activating composition based on the total weight of the metal alloy, the metal alloy comprises greater than or equal to 1 wt. % and less than or equal to 10 wt. % of the activating composition based on the total weight of metal alloy). In some embodiments, the metal alloy the activating composition is incorporated into may be an aluminum alloy, though other water reactive materials may also be used. Other ranges are also possible.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

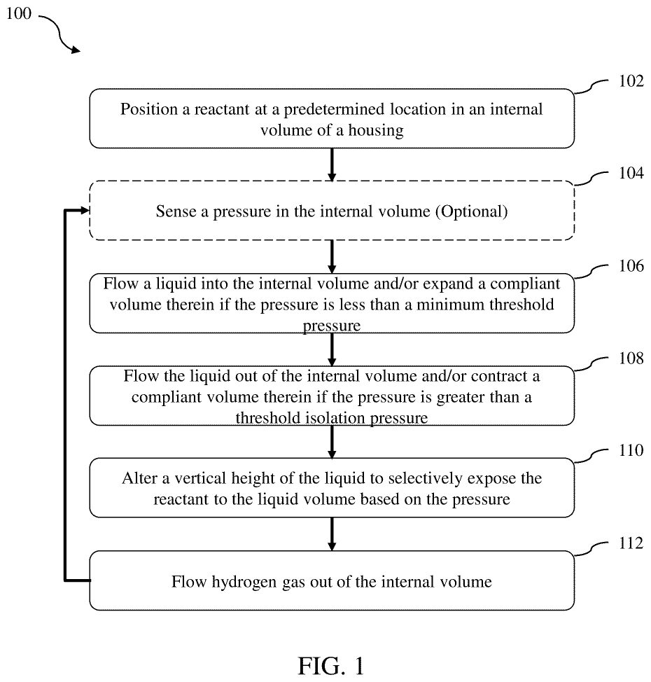

FIG. 1 illustrates a method flow diagram 100 for generating hydrogen. At 102, the method includes positioning a reactant at a predetermined location within an internal volume of a housing of a reactor. This can include supporting the reactant from a support within the internal volume. Depending on the embodiment, the predetermined location may be spaced apart from one or more internal surfaces of the internal volume. At 104, a pressure in the internal volume is optionally sensed with one or more pressure sensors. Sensing may be performed in systems utilizing active controls such as a pressure sensor and controller configured to actuate a pump or other source of pressurized liquid.

At 106, if the pressure within the internal volume is less than a minimum threshold pressure, water may flow into the internal volume and/or a compliant volume disposed in the reactor internal volume may expand. In a system utilizing a separate source of pressurized liquid such as a pump, the pump may flow a liquid from a liquid reservoir into the internal volume at a desired minimum threshold pressure. In systems using passive control, such as a system including a compliant volume in fluid communication with the internal volume, a liquid may flow from the compliant volume into the internal volume. Alternatively, in embodiments including a compliant volume disposed in the reactor internal volume, the compliant volume may expand within the internal volume. At step 108, if the pressure is above a threshold isolation pressure, the method includes flowing water out of the internal volume through an outlet in fluid communication with the internal volume. In systems utilizing a pump, the system may operate a valve, pump, or other fluid control device to flow liquid out of the internal volume. In systems using passive control, water may flow from the internal volume into the compliant volume. Alternatively, in embodiments including a compliant volume disposed in the reactor internal volume, the compliant volume may contract within the internal volume.

Due to changes in pressure within the internal volume, a vertical height of the liquid relative to a direction of gravity during operation of the reactor may be altered. At 110, a vertical height of the liquid within the internal volume in the direction of gravity is altered due to the flow of the liquid into or out of the internal volume. In systems with the compliant volume, altering the vertical height of the liquid comprises changing a total volume of the compliant volume in response to changes in pressure within the internal volume. In some embodiments, this may include flowing liquid from the internal volume into the compliant volume. In other embodiments, this may include compressing and/or expanding the compliant volume, where the compliant volume is fluidly isolated from the internal volume. Alternatively, in actively controlled reactors, the change in height of the liquid simply corresponds to the flow of liquid into and out of the reactor internal volume.

By altering the vertical height of the liquid, the reactant may be selectively exposed or isolated from the liquid to control the production of hydrogen or another appropriate gas. It should be understood that the flow of the liquid into or out of the volume may be due to the pressure within the internal volume and the flow may be controlled either actively or passively. In a system using an internal compliant volume, the amount of liquid in the internal volume will not change because the liquid does not flow into or out of the volume. Instead, in such a system, the total volume of the internal compliant volume is manipulated (e.g. compressed or expanded) based on the pressure within the internal volume. Since the internal compliant volume is submerged in the liquid, this manipulation alters the vertical height of the liquid within the internal volume.

Once hydrogen has been produced in the internal volume, hydrogen may flow out of the internal volume through an outlet formed in the housing that is in fluid communication with the internal volume at 112. Flowing hydrogen out of the internal volume may decrease the internal pressure. This process may continue throughout a gas generation process. Thus, the method may repeat from 104 as shown in the figure.

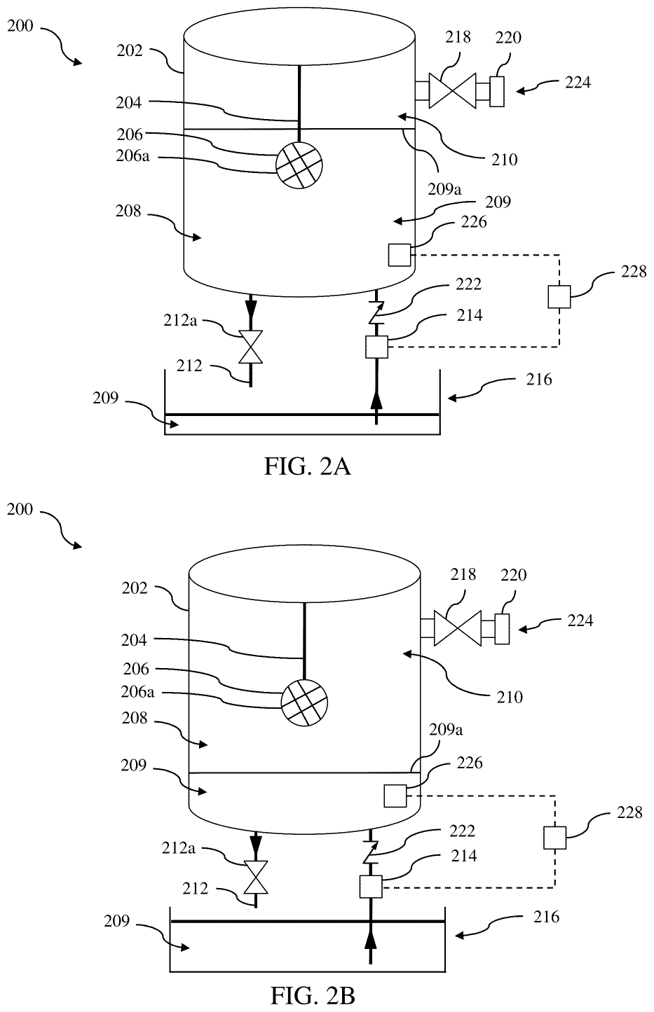

FIG. 2A is a schematic of one embodiment of a reactor 200 including active control of the internal pressure to be within a desired pressure range to control a liquid level therein to selectively expose the reactant 206 to the liquid. In the depicted embodiment, reactor 200 includes a housing 202 with an internal volume 208 formed therein. Water 209, or other appropriate liquid, may be disposed within internal volume 208 such that a first portion of the internal volume is filled with the water 209 and a second portion of the volume contains a head space 210 filled with gas. As discussed previously, the housing 202 may be any rigid, non-reactive material configured to contain the reaction and withstand the applied pressures and temperatures within the internal volume 208 during operation.

The reactor further includes a support 204 attached to the interior of the housing 202 at a first end portion and attached to a reactant 206 at a second end portion. Support 204 may be configured to support the reactant 206 at a predetermined location within the internal volume 208. In some embodiments, the reactant 206 may be contained within reactant container 206a connected to the support 204, though embodiments in which the reactant 206 is directly connected to the support 204 are also contemplated. In the depicted embodiment, the support 204 supports the reactant 206 at a predetermined location that is spaced apart from one or more internal surfaces of the internal volume. For example, the predetermined location may be spaced apart from an underlying bottom surface as well as the other side surfaces of the internal volume 208 during operation relative to a direction of gravity. This may permit the water level 209a to be changed to selectively expose and isolate the reactant 206 from the water as elaborated on below. As previously described above, the support 204 may be any appropriate material and have any desired rigidity as the disclosure is not so limited. It should also be appreciated that the reactant container 206a may have any appropriate configuration, construction, size, and/or shape configured to contain the reactant 206 while exposing it to the internal volume 208 as the disclosure is not so limited.

The reactor 200 may include a gas outlet 224 formed in the housing and in fluid communication with internal volume 208. The gas outlet may be disposed at a location vertically above the reactant 206 relative to a direction of gravity during operation of the reactor. The gas outlet 224 may include an isolation valve 218 and a connector 220 configured to connect the gas outlet 224 to an associated system. Isolation valve 218 may be any appropriate valve (gate valve, ball valve, butterfly valve, pinch valve, etc.) and may be formed of any appropriate material (plastic, metal, composite, etc.). Depending on the embodiment, it is also contemplated that the valve may be actuated manually, pneumatically, electronically, and/or in any other appropriate fashion as the disclosure is not so limited. Connector 220 may be any desired connector as the disclosure is not so limited. For example, connector 220 may comprise a threaded coupler, quick connect, or other appropriate connector capable of connecting the outlet 224 to a desired system for outputting the generated gas thereto. In some embodiments, the connector 220 itself may include a valve configured to selectively isolate the internal volume such that a separate valve is not needed, though embodiments in which a valve is not used are also contemplated.

A source of pressurized liquid such as the depicted pump 214 may be configured to flow water from a liquid reservoir 216 into the internal volume. For example, the pump 214 may be fluidly coupled to the internal volume 208 via conduits, piping, direct connection, or other appropriate structures such that the pump may pump liquid from the liquid reservoir 216 to the internal volume 208. In some embodiments, the pump or other source of pressurized liquid may be configured to flow the water into the internal volume 208 at a minimum threshold pressure. A one-way valve 222 (e.g. a check valve) may be disposed along a flow path between the pump 214 and the internal volume such that water can only flow from the liquid reservoir 216 and into the internal volume 209 through the flow path including the pump 214. This may be beneficial to prevent back flow through the pump 214 when the internal pressure of the internal volume 208 is increased.

During operation, one or more pressure sensors 226 may measure a pressure within the internal volume (e.g. gas pressure, water pressure, etc.). The system may also include one or more controllers 228 including one or more processors and associated non-transitory computer readable memory including processor executable instructions that when executed perform any of the methods disclosed herein. The one or more sensors 226 may be configured to output signals corresponding to the sensed pressure to the one or more controllers 228 which may be configured to control the pump 214 based at least in part on the sensed pressure. For example, when the internal pressure is less than the minimum threshold pressure, the pump 214 may pump water from the liquid reservoir 216 into the internal volume 208 to increase the amount of water within the internal volume. This may increase the water level 209a within the internal volume which may then expose the reactant to the water 209, causing hydrogen to be produced. Alternatively, the pump 214 may simply be continuously operated to provide pressurized water, or other liquid, at the minimum threshold pressure in other embodiments not including actively sensed pressures and variable control of the pump 214. Thus, using the embodiments of FIGS. 2A and 2B, the pump 214 may be used to flood the reactor to produce pressurized hydrogen.

As noted above, during operation, pump 214, or another source of pressurized liquid, may fill the internal volume 208 with water 209. With the reactant 206 located below the water line 209a as in FIG. 2A, the water may flood over the reactant to produce hydrogen gas within the internal volume 208. The hydrogen gas may collect within head space 210 and increase an internal pressure within the internal volume. If the internal pressure exceeds a threshold isolation pressure, the water 209 may flow through a liquid outlet 212 in fluid communication with the internal volume 208. Depending on the embodiment, the liquid outlet 212 may be formed in the housing 202. The liquid outlet may be configured to prevent water 209 from flowing out of the internal volume 208 when the pressure is less than the threshold isolation pressure while permitting the water 209 to flow out of the internal volume 208 when the pressure is greater than the threshold isolation pressure. As noted previously, the threshold isolation pressure may be greater than a minimum threshold pressure.

In the depicted embodiment, the liquid outlet 212 comprises a valve 212a configured to selectively permit and prevent water 209 from flowing through the liquid outlet 212. The valve 212a may be configured to open when the internal pressure exceeds the threshold isolation pressure. It is contemplated that the valve 212a may be any appropriate valve such as a pressure relief valve, a check valve with an appropriate cracking pressure, actively controlled valves controlled by the controller 228, and/or any other appropriate type of valve as the disclosure is not so limited. Upon valve 212a opening in response to the pressure exceeding a threshold isolation pressure, water 209 may flow from the internal volume through the liquid outlet 212, causing a vertical height 209a of the water in the direction of gravity to decrease. The water 209 may flow into a liquid reservoir 216 configured to contain the water 209, see FIG. 2B. By flowing water 209 out of the internal volume 208, the internal pressure within the internal volume 208 may decrease. Flowing water 209 out of the internal volume 208 may also decrease the vertical height 209a of the water 209 in the direction of gravity (e.g. lower the water level 209a) within the internal volume 208. Lowering the water level 209a may correspondingly isolate the reactant 206 from the water 209, thereby decreasing and/or stopping a rate of the reaction between the water 209 and the reactant 206.

During operation, reaction of the reactant 206 and water 209 may generate hydrogen which may flow out of the gas outlet 224. Flowing hydrogen out of the internal volume 208 may depending on the rate of hydrogen generation versus flow rate, either increase or decrease the internal pressure. As noted previously, depending on whether the pressure is greater than the threshold isolation pressure or is less than a minimum threshold pressure, the water 209 may either flow into or out of the internal volume 208 to control the water level 209a to selectively expose or isolate the reactant 206 from the water 209. Thus, the reactor may be configured to maintain the internal pressure within the reactor within a desired pressure range between the minimum threshold pressure and the threshold isolation pressure, where the minimum threshold pressure is less than the threshold isolation pressure.

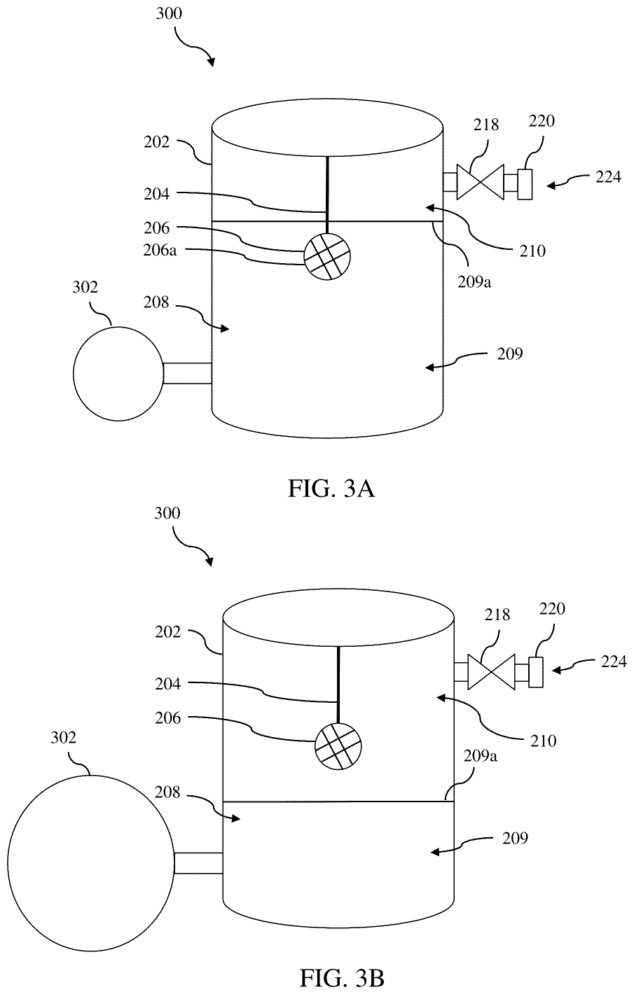

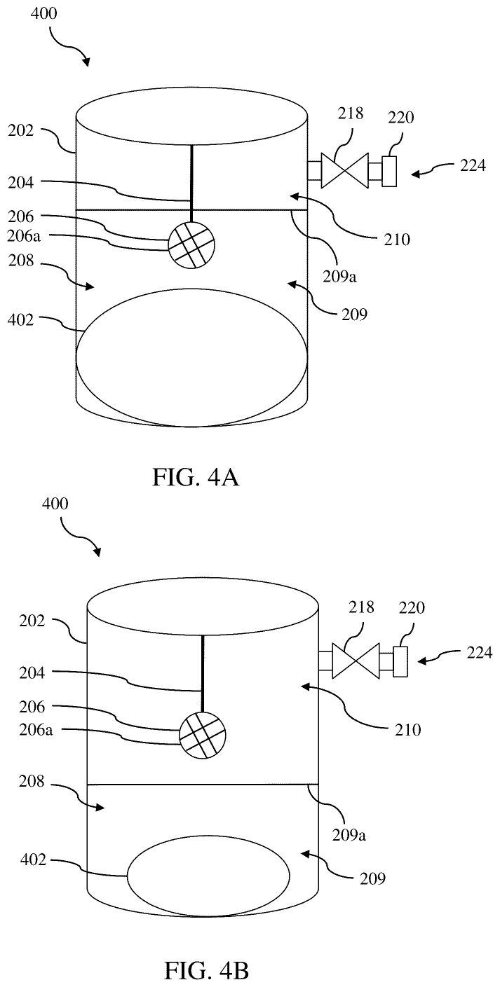

FIGS. 3A to 4B depict embodiments of a flooding reactor wherein the pressure source is a compliant volume. Depending on the embodiment, the compliant volume may include at least one selected from a pressurized accumulator in fluid communication with the internal volume, an expansion tank in fluid communication with the internal volume, a gas bladder disposed in and fluidly isolated from the internal volume, an elastic bladder in fluid communication with the internal volume, an elastic diaphragm, or any other appropriate compliant volume configured to pressurize a liquid contained within a reactor to control a height of a liquid contained therein as the disclosure is not so limited. In FIGS. 3A to 4B, a total volume of each compliant volume changes in response to changes in the pressure in the internal volume, thus varying the water level within the depicted reactors. These embodiments are elaborated on further below in reference to the associated figures.

Turning to FIG. 3A., a reactor 300 is depicted. Similar to the previous embodiments, a reactor 300 comprises a housing 202 including an internal volume 208. Water 209 may be disposed within the internal volume 208 and the support 204 may support the reactant 206 within an optional reactant container 206a at a predetermined location within the internal volume 208. The reactor 300 may further comprise a gas outlet 224 formed in the housing 202 in fluid communication with the internal volume 208. The gas outlet 224 may be configured to flow hydrogen gas from the internal volume to an associated system. The gas outlet may also comprise an isolation valve 218 and a connector 220 as previously discussed. In this embodiment, the water 209 may be flowed into the reactor 300 prior to closing the reactor. Alternatively, a pump, not depicted, may be used to flow water 209 into the internal volume 208.

In the depicted embodiment, the reactor 300 includes an external compliant volume 302 that is located externally to the internal volume 208. The external compliant volume 302 is in fluid communication with the internal volume 208 such that water 209 may flow into and out of the external compliant volume 302. As previously described, exposing the reactant 206 to the water 209 may generate hydrogen within the internal volume 208. As hydrogen collects within the head space 210, pressure within the internal volume 208 may increase. This increase in pressure may cause water 209 to flow out of the internal volume 208 and into the external compliant volume 302, thereby lowering the water level 209a. When the pressure is high enough (e.g., above a threshold isolation pressure), the water level 209a may fall below the reactant 206 causing the reactant to be isolated from the water as seen in FIG. 3B. Correspondingly, when the pressure is lower than the threshold isolation pressure, the water level 209a may be low enough such that at least a portion of the reactant 206 is exposed to the water 209. The external compliant volume 302 may also be configured to maintain a minimum threshold pressure in the internal volume. It is contemplated that the threshold isolation pressure and minimum threshold pressure of the reactor 300 may be tuned by varying a compliance of the external compliant volume, varying an amount of reactant, varying the location of the reactant within the internal volume, varying a ratio of water volume to total internal volume, or any other appropriate parameter as the disclosure is not limited in this manner.

While operating modes where the reactant 206 is fully immersed or isolated from the water 209 are detailed above, in some embodiments, it is possible that the reactor 300 may operate in a manner such that the reactant 206 is only partially immersed in the water 209 as well. Additionally, it is contemplated that in some embodiments where a plurality of reactants 206 may be located at more than one predetermined location in an internal volume 208 for selectively exposing or isolating the separate reactants to the water. For example, the reactor may operate in a manner where a reactant located at a first location may be at least partially exposed to water 209, while a reactant located at a second location may be isolated from the water 209. Of course, there may may reactant located at more than two predetermined locations within the internal volume as the disclosure is not so limited.

FIGS. 4A and 4B depicts an alternative embodiment utilizing a compliant volume. In the depicted embodiment, an internal compliant volume 402 is included in an internal volume 208 of the reactor 400. The internal compliant volume 402 may be configured to expand and contract depending on the pressure to vary an available portion of the internal volume 208 for accommodating the gas head 210 and water 209. FIG. 4A is a schematic of the reactor 400 when an internal pressure is within a desired pressure range (i.e., between a minimum threshold pressure and a threshold isolation pressure greater than the minimum threshold pressure) with the reactant 206 exposed to water 209. Many features of reactor 400 are similar to reactor 300, which can be fully understood through the descriptions of the previous embodiments. However, as noted above, the reactor 400 includes an internal compliant volume 402 disposed within and fluidly isolated from the internal volume. The internal compliant volume may be pre-pressurized and/or may be made from a compressible material as the disclosure is not so limited. The internal compliant volume 402 may be at least partially submerged in the water 209 within the reactor chamber during operation. This can allow the internal compliant volume 402 to displace water 209 such that changing the volume of the internal compliant volume can alter the water level 209a.

During hydrogen generation, pressure within the internal volume may compress the internal compliant volume, thereby decreasing a total volume of the internal compliant volume. Such a decrease may lower the water level 209a (e.g. decrease a vertical height of the water within the internal volume). If the pressure is high enough (e.g., greater than the threshold isolation pressure), the internal compliant volume will be sufficiently compressed such that the water level 209a may be decreased such that the reactant may be fully isolated from the water 209 as depicted in FIG. 4B. Correspondingly, as hydrogen gas flows out from outlet 224, the pressure may decrease causing the internal compliant volume 402 to expand causing the water level 209a to rise and again exposing the reactant 206 to the water 209. Similar to the above embodiments, it is contemplated that the threshold isolation pressure and minimum threshold pressure of the reactor 400 may be tuned by varying the different operating and design parameters of the reactor 400 as discussed previously.

The embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A reactor for producing gas, the reactor comprising:
a housing including an internal volume;
a support configured to support a reactant in a predetermined location within the internal volume, wherein the predetermined location is spaced apart from one or more internal surfaces of the internal volume; and
a pressure source configured to maintain a pressure of a liquid in the internal volume greater than or equal to a minimum threshold pressure.

2. The reactor of claim 1, wherein the pressurized liquid source is a pump.

3. The reactor of claim 2, further comprising a liquid outlet in fluid communication with the internal volume, wherein the liquid outlet is configured to prevent the liquid flowing out of the internal volume through the liquid outlet when the pressure is less than a threshold isolation pressure and permit the liquid to flow out of the internal volume through the liquid outlet when the pressure is greater than the threshold isolation pressure, wherein the minimum threshold pressure is less than the threshold isolation pressure.

4. The reactor of claim 3, wherein a vertical height of the liquid in a direction of gravity decreases in response to the liquid flowing out of the liquid outlet when the pressure is greater than the threshold isolation pressure.

5. The reactor of claim 1, wherein the pressure source comprises a compliant volume associated with the internal volume, wherein the compliant volume is configured to alter a vertical height of the liquid disposed in the internal volume relative to a direction of gravity in response to changes in the pressure of the internal volume during operation.

6. The reactor of claim 5, wherein a total volume of the compliant volume changes in response to the changes in the pressure.

7. The reactor of claim 5, wherein the compliant volume includes at least one selected from a pressurized accumulator in fluid communication with the internal volume, an expansion tank in fluid communication with the internal volume, a gas bladder disposed in and fluidly isolated from the internal volume, and an elastic bladder in fluid communication with the internal volume.

8. The reactor of claim 1, further comprising the reactant disposed in the internal volume and attached to the support.

9. The reactor of claim 8, wherein the liquid is water and the reactant is a water reactive material, and further comprising the water disposed in the internal volume.

10. The reactor of claim 8, wherein the reactant includes at least one selected from the group of aluminum, sodium, magnesium, zinc, boron, beryllium, and alloys thereof.

11. The reactor of claim 10, wherein the reactant is an alloy of aluminum, gallium, and indium.

12. The reactor of claim 1, further comprising a gas outlet formed in the housing and in fluid communication with the internal volume.

13. A method of producing gas, the method comprising:
combining a reactant and a liquid in an internal volume of a housing to produce the gas; and
altering a vertical height of the liquid in a direction of gravity within the internal volume in response to changes in a pressure within the internal volume to selectively expose the water reactive material from the liquid.

14. The method of claim 13, further comprising supporting the reactant in a predetermined location within the internal volume, wherein the predetermined location is spaced apart from one or more internal surfaces of the internal volume.

15. The method of claim 13, wherein altering the vertical height of the liquid comprises flowing the liquid into the internal volume when the pressure of the internal volume is less than a minimum threshold pressure.

16. The method of claim 13, wherein altering the vertical height of the liquid comprises flowing the liquid from the internal volume through an outlet when the pressure is greater than a threshold isolation pressure, wherein the minimum threshold pressure is less than the threshold isolation pressure.

17. The method of claim 14, wherein altering the vertical height of the liquid comprises changing a total volume of a compliant volume associated with the internal volume in response to changes in the pressure.

18. The method of claim 17, wherein changing the total volume of the compliant volume comprises flowing the liquid into the compliant volume.

19. The method of claim 17, wherein the compliant volume is disposed in and fluidly isolated from the internal volume.

20. The method of claim 14, further comprising flowing the gas out of the internal volume.

21. The method of claim 13, wherein the reactant includes at least one selected from the group of aluminum, sodium, magnesium, zinc, boron, beryllium, and alloys thereof.

22. The method of claim 13, wherein the reactant is an alloy of aluminum, gallium, and indium.

23. The method of claim 13, wherein the liquid is water and the reactant is a water reactive material.
